(19) United States
(12) Patent Application Publication
(10) Pub. No.: US 2006/0125787 A1
(43) Pub. Date: Jun. 15, 2006

(54) Data processing system

(75) Inventor: Allan Cheng, Copenhagen (DK)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/289,871

(22) Filed: Nov. 30, 2005

(30) Foreign Application Priority Data
Dec. 15, 2004 (GB) 0427548.3

(51) Int. Cl. G09G 5/00

(52) U.S. Cl. 345/156

(57) ABSTRACT

A data processing system including: a display screen; a keyboard; a sensor subsystem for generating a sensed output indicative of the position of the display screen relative to the keyboard; a memory for storing one or more outputs from the sensor subsystem; a comparator for generating feedback indicative of the difference between the output from the sensor subsystem and an output stored in the memory; and, communication means for communicating the feedback to a user of the data processing system.

### FIELD OF THE INVENTION

The present invention generally relates to a data processing system and particularly relates to screen positioning in a data processing system.

### BACKGROUND OF THE INVENTION

A conventional data processing system comprises a central processing unit (CPU), a memory subsystem, an input/output (I/O) subsystem, and a bus subsystem interconnecting the memory subsystem, I/O subsystem, and the CPU. The I/O subsystem typically comprises a display screen and a keyboard. Computer program code executable by the CPU is stored in the memory subsystem. The computer program code includes an operating system together with one or more applications such as word processors and similar software tools that can be selectively run on the operating system according to user requirements. An example of such a data processing system is a personal computer (PC) system. In a PC system, the memory subsystem and the CPU are typically integrated into a system unit. In a desktop PC system, the display device and keyboard of the I/O subsystem are typically separate from the system unit. Such desktop PC systems are commonplace in conventional office spaces.

In a conventional office space, each user is typically assigned dedicated office furniture, together with a desktop PC system. For each user, these articles can be adjusted according to ergonomic requirements and/or preferences.

Portable PC systems are becoming increasingly popular. An example of such a portable PC system is the so-called “laptop” PC system. In a laptop PC, the keyboard is integral to the system unit, along with the CPU and memory subsystem. Usually, the display screen is pivotally mounted on the system unit to form a bivalve enclosure with the system unit. Examples of conventional laptop PCs are described in U.S. Pat. No. 6,005,767, U.S. Pat. No. 5,345,362, and U.S. Pat. No. 5,168,426.

The increasing availability of laptop PCs is at least partially linked to an increasing population of remote working mobile users. The office requirements of such mobile users are different to those of conventional office workers. Accordingly, there is a trend towards replacing conventional office spaces with open workspaces in which desks, chairs, and other facilities are no longer assigned to individual users. Instead, office furniture is free for use by visiting users simply according to availability. On each visit, a user may find desk height, chair height, and backrest position in need of adjustment before a comfortable working posture is attained. Similarly, the user may have to re-establish a suitably ergonomic position for the display screen of a laptop PC. An incorrectly positioned display screen can lead to undesirable stress in the user's neck and/or back. However, such positioning and repositioning can be laborious and involves guessing what feels right. The display screen position eventually arrived at may be incorrect from an ergonomic perspective. It would be desirable to permit a predetermined position of the display screen relative to the system unit to be more easily re-established.

### SUMMARY OF THE INVENTION

In accordance with the present invention, there is now provided a data processing system comprising: a display screen; a keyboard; a sensor subsystem for generating an output indicative of the position of the display screen relative to the keyboard; a memory for storing one or more outputs from the sensor subsystem; a comparator for generating feedback indicative of any difference between the output from the sensor subsystem and an output stored in the memory; and, communication means for communicating the feedback to a user of the data processing system.

Preferably the system further comprises means for selecting one of a plurality of outputs from the sensor subsystem stored in the memory, wherein the feedback generated by the comparator is indicative of any difference between the output from the sensor subsystem and the selected output. The communication means preferably displays an image indicative of the feedback on the display screen. The sensor subsystem preferably comprises at least one rotational sensor for sensing an angle of tilt of the display screen relative to the keyboard, and at least one linear sensor for sensing a distance between the display screen and the keyboard. The output from the sensor subsystem preferably comprises a plurality of values each associated with a different sensor of the subsystem.

Viewing the present invention from another aspect, there is now provided a method for positioning a display screen of a data processing system relative to a keyboard of the data processing system, the method comprising: generating, via a sensor subsystem, an output indicative of the position of the display screen relative to the keyboard; storing one or more outputs from the sensor subsystem; and, generating feedback indicative of any difference between the output from the sensor subsystem and an output stored in the memory; and, communicating the feedback to a user of the data processing system.

A preferred embodiment of the present invention provides guidance to assist a user of a laptop PC in swiftly finding a specific position of the display screen relative to the keyboard. In a particularly preferred embodiment of the present invention, there is provided a laptop PC in which display screen positions can saved in ergonomic profiles. Each profile may correspond to a different user. This may be useful where the laptop PC is shared by multiple users. Alternatively, each profile may correspond to a different operating environment. For example, one profile may correspond to the user working at a desk. Another profile may correspond to the user working while travelling, for example, on a passenger aircraft, or in a railway carriage.

The guidance may be provided to the user visually via the display screen. Additionally or alternatively, the guidance may be provided via a loudspeaker of the laptop PC. A combination of audio and visual guidance may be employed.

In a preferred embodiment of the present invention to be described shortly, there is a provided a laptop PC in which the display screen is connected to the system unit via arms. The arms extend from opposing sides of the system unit to opposing sides of the display screen. Each arm is pivotally and slidably connected to the display screen. The arms are articulated at a pivot point along their length. The pivot points in each arm share a common pivotal axis. Each arm is slideably connected to the system unit so that the pivotal axis can be laterally moved towards or away from the system unit. Sensors are provided for sensing pivotal and lateral movements of the arms and the display screen. The outputs of the sensors are indicative of the positions of the arms and display screen relative to the keyboard. In operation, the outputs from the sensors are monitored. As the position of the display screen relative to the system unit is adjusted, the outputs of the sensors vary accordingly. When the display screen is moved into a desired position relative to the keyboard, the outputs of the sensors have values indicative of the desired position. Such a position may be arrived at through ergonomic considerations. The outputs of the sensors can then be recorded to capture data indicative of the desired position. Such captured data may be recorded as an ergonomic profile for the user. The recorded outputs from the sensors may be thought of as collectively constituting a vector defining the desired position of the display screen relative to the keyboard.

When the laptop PC is switched off, the display screen may be collapsed against the system unit to facilitate stowage. When the laptop PC is reactivated, the user is offered the opportunity to adjust to one of the profiles recorded. Different profiles may be made available to and/or recorded by different users each having a different user log on account on the same laptop PC.

The outputs of the sensors provide real time measurements of the current position of the display screen relative to the keyboard. Thus, the outputs of the sensors can be translated into visual and/or audio feedback to the user for guiding the user in positioning the display screen according to a selected pre-recorded profile. The user can thus easily unpack the laptop PC and re-establish a desired position of the display screen relative to the keyboard.

A preferred position for the display screen relative to the keyboard may be determined by the user through consultation with an ergotherapist and the corresponding outputs of the sensors saved as a profile for subsequent use. Embodiments of the present invention may be modified to detect the form of work being done by the user, to detect the conditions in which the work is being done, and to encourage the user to switch between different positional settings of the display screen to provide variety in an otherwise monotonous working position.

### BRIEF DESCRIPTION OF THE DRAWINGS

Embodiments of the present invention will now be described, by way of example only, with reference to the accompanying drawings, in which:

FIG. 1 is a block diagram of a data processing system embodying the present invention;

FIG. 2 is a perspective view of the data processing system;

FIG. 3 is another perspective view of the data processing system in an extended configuration;

FIG. 4 is a flow chart associated with the data processing system;

FIG. 5 is a displayed image associated with the data processing system;

FIG. 6 is another displayed image associated with the data processing system;

FIG. 7 is yet another displayed image associated with the data processing system;

FIG. 8 is a further displayed image associated with the data processing system;

FIG. 9 is still another displayed image associated with the data processing system; and,

FIG. 10 is also a displayed image associated with the data processing system.

### DETAILED DESCRIPTION OF PRESENT INVENTION

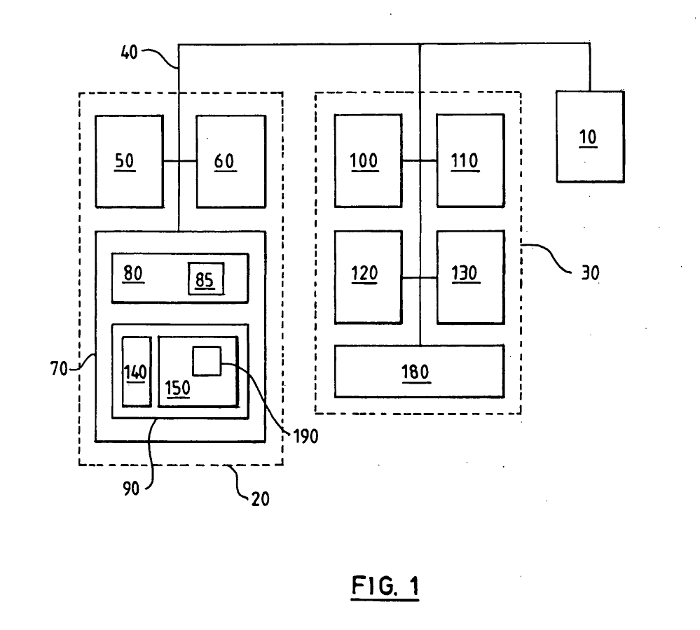

Referring first to FIG. 1, a preferred example of a data processing system embodying the present invention comprises a CPU 10, a memory subsystem 20, an I/O subsystem 30, and a bus subsystem 40 interconnecting the memory subsystem 20, I/O subsystem 30, and the CPU 10.

The memory subsystem 20 comprises relatively high speed memory devices such as a solid state random access memory (RAM) 50 and a read only memory (ROM) 60, together with at least one relatively low speed mass data storage device such as a magnetic hard disk storage device 70. In operation, the memory subsystem 20 stores data 80 and computer program code 90 executable by the CPU 10. In operation, the CPU 10 executes the computer program code 90 to manipulate the data 80. The computer program code 90 includes an operating system 140 together with one or more applications 150 such as word processors and similar software tools that can be selectively run on the operating system 140 according to user needs.

The I/O subsystem 30 comprises user input devices such as a keyboard 100 and a pointing device 110. The pointing device may include a track ball, joystick, touch pad, or a similar transducer. The I/O subsystem 30 also includes user output devices such as a display screen 120, and loudspeaker 130. The I/O subsystem 30 further includes at least one communications adapter for connecting the data processing system to one or more similar systems via one or more intervening wired or wireless data communications networks.

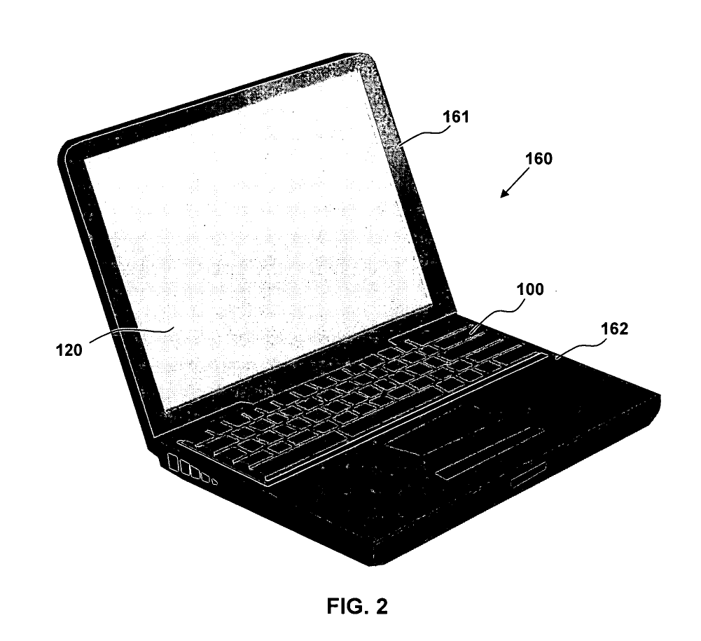

Referring now to FIG. 2, in a particularly preferred embodiment of the present invention, the data processing system is in the form of a laptop PC comprising a bivalve enclosure 160 having a first portion 161 and a second portion 162. The display screen 120 of the I/O subsystem 30 is housed in the first portion 161 of the enclosure 160. The keyboard 100 and the remainder of the I/O subsystem 30 is housed in the second portion 162 of the enclosure 160, together with the CPU 10, the memory subsystem 20, and the bus subsystem 40. The first portion 161 is pivotally connected to the second portion 162 via hinge linkages to permit opening of enclosure 160 for use of the PC system therein and closing of the enclosure 160 for stowage during periods of non-use. Battery and power supply subsystems are located in the second portion 162 of the enclosure 160. A flexible cable having multiple electrically conductive lines permit communication of display drive signals and power from the second portion 162 of the enclosure 160 to the display screen 120 in the first portion 161 of the enclosure 160.

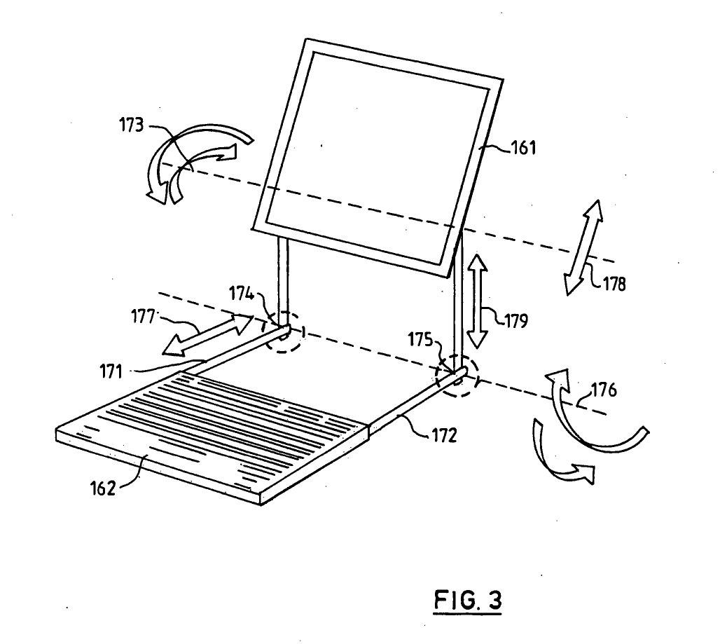

Referring now to FIG. 3, the first portion 161 housing the display screen 120 is connected to the second portion 162 housing the keyboard 100 via a pair of arms 171 and 172. The arms 171-172 extend from opposing sides of the second portion 162 to opposing sides of the first portion 161.

Each arm 171-172 is pivotally and slidably connected to the first portion 161 at a pivot point. Each pivot point may comprise, for example a laterally extending flanged formation towards the end of each arm 171-172 rotatably keyed into a necked groove extending along the opposing side of the first portion 161. The pivotal and sliding connections at the ends of the arms 171-172 share a first common pivotal axis 173 of inclination of the display screen 120 relative to the arms 171-172. The sliding connections permit movement of the display screen 120 relative to the first pivotal axis 173 along the axis indicated by arrow 178. The pivot points are also slidably connected to the arms 171-172 to permit movement of the first pivotal axis 173 along the arms 171-172 along the arrow 179. This slidable connection may be achieved by each pivot point comprising a laterally extending flanged formation keyed into a necked groove extending along the corresponding arm 171-172.

Each arm 171-172 is articulated at a hinge 174-175 disposed along its midpoint. The hinges 174-175 in each arm share a second common pivotal axis 176.

The end of each arm 171-172 remote from the first portion 161 is slideably connected to the second portion 162. Thus, the second pivotal axis 174 can be laterally moved towards or away from the keyboard 100 in the second portion 162 as indicated by arrow 177. The sliding connections may provided by, for example, complementary formations such as tongue and groove formations on the arms 171-172 and the opposing sides of the second portion 162.

The hinges, pivot points, and other moveable connections between the arms 171-172, the first portion 161, and the second portion 162 each exhibit sufficient stiffness to retain a positioning of the display screen 120 by the user. Such stiffness may be provided by, for example, frictional forces between moveable parts interconnected in an interference fit.

The flexible cable between the first portion 161 and the second portion 162 has sufficient play to permit full extension of the arms 171-172 and location of the display screen at the extremity of the arms 171-172. In particularly preferred embodiments of the present invention, the cable is retractable into one of the first portion 161 and the second portion 162. The retraction may be automatically actuated via a spring bias.

Returning to FIG. 1, the I/O subsystem 20 further comprises a sensor subsystem 180 for sensing pivotal and lateral movements of the arms 171-172 and the display screen 120. The application software 150 comprises control code 190. The output of the sensor subsystem 180 is indicative of the positions of the arms 171-172 and display screen 120 relative to the keyboard 100 in the second portion 162. The sensor subsystem 180 may comprise potentiometers such as rotary and linear potentiometers. Alternatively, the sensor subsystem 180 may comprise optical encoders such as shaft and linear encoders.

Pivotal axes 173 and 176, together with translational axes 178 and 177 provide four degrees of movement of the display screen 120 relative to the keyboard 100. In a preferred embodiment of the present invention, each of these four degrees of movement corresponds to a different sensor in the subsystem 180. Accordingly, the output of the sensor subsystem 180 comprises four components each corresponding to a different degree of movement.

In operation, the output from the sensor subsystem 180 is monitored by the control code 190 executing on the CPU 10.

As the position of the display screen 120 relative to the keyboard 100 is adjusted, the output of the sensor subsystem 180 varies accordingly. When the display screen 120 is moved into a desired position, the output of the sensor subsystem 180 is indicative of the desired position. Such a position may be set by the user based on ergonomic considerations. The output of the sensor subsystem 180 can then be recorded in the memory subsystem 20 to capture data indicative of the desired position. The recording may be effected via the user depressing an assigned function key on the keyboard 100 for example. Such captured data may be thus recorded as an ergonomic profile for the user. The recorded output from the sensor subsystem 180 may be thought of as collectively constituting a vector defining the desired position of the display screen 120 relative to the keyboard 100.

In a preferred embodiment of the present invention, by depressing another assigned function key, the control code 190 may show a representation of the current position of the display screen 120 relative to a target position based on a stored profile. The representation provides visual feedback for guiding the user towards that position. The representation may be in for form of a small picture in a desktop window on the display screen 120. Alternatively, the representation may be superimposed as an overlay on the display screen 120. Other representations are also possible. Additionally or alternatively, audio feedback may be provided via a loudspeaker. The feedback can be provided in real-time until the display screen 120 is positioned within a predetermined tolerance of the target position as defined by the profile.

When the laptop PC is switched off, the display screen 120 may be collapsed against the system unit to facilitate stowage. In a preferred embodiment of the present invention, when the laptop PC is reactivated, the user is offered the opportunity to adjust to one of the stored profiles. Different profiles may be made available to and/or recorded by different users each having a different userid.

The output of the sensor subsystem 180 provides real time measurements of the current position of the display screen 120 relative to the keyboard 100. The user can thus easily re-establish a desired position of the display screen 120 relative to the keyboard 100. A desirable position for the display screen 120 relative to the keyboard 100 may be determined by the user through consultation with an ergotherapist.

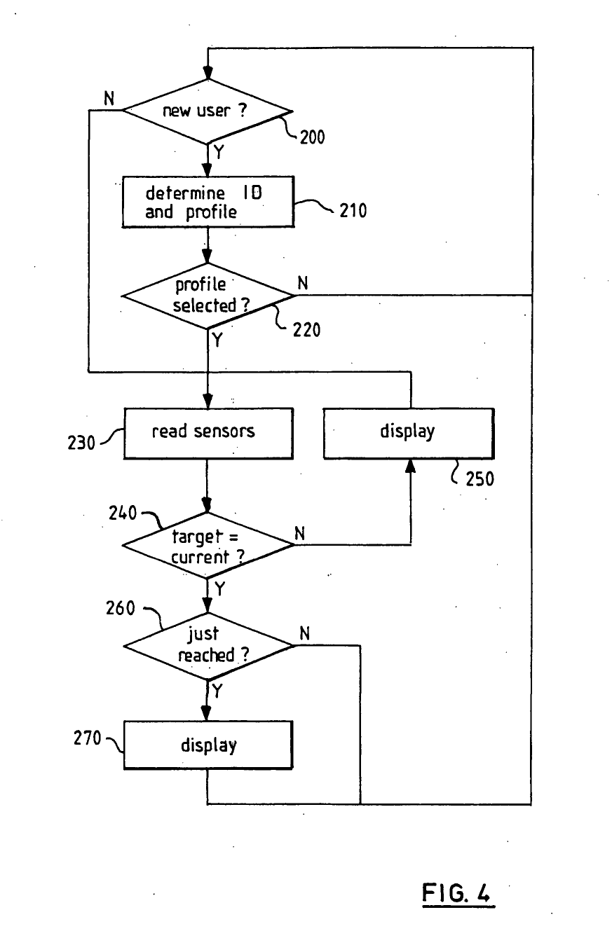

Execution of an example of the control code 190 by the CPU 10 will now be described with reference to FIG. 4. From a brief perusal of FIG. 4 it will be apparent to those skilled in the art that the control code 190 may be implemented in one or more of a range of computer programming languages.

At step 200, the control code 190 determines if there is a new user of the laptop PC. If not, the control code 190 jumps to step 230. If so, the control code 190 determines, at step 210, the userid of the new user. Based on the userid determined, the control code 190 retrieves any associated profiles recorded in a look up table 85 in the memory subsystem 20.

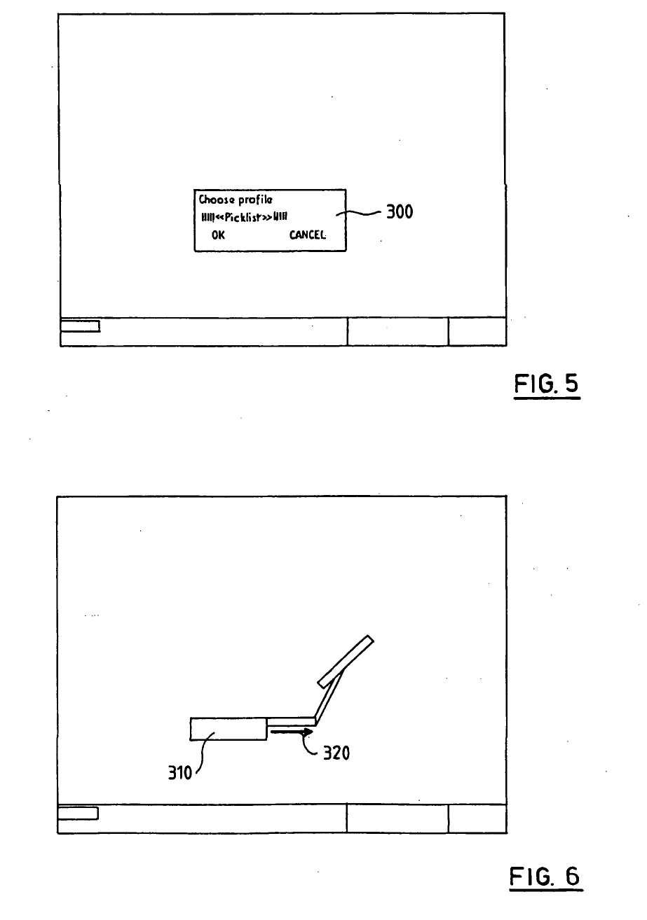

Referring to FIG. 5, the control code 190 presents the retrieved profiles in an overlay 300 on the display screen 120. The control code 190 invites the user to select a desired a profile via the overlay 300.

Returning to FIG. 4, at step 220, the control code 190 detects if the user has selected a desired profile. If not, then the control code 190 returns to step 200. If so, the control code 190 sets a target profile to the selected profile. Then, at step 230, the control code 190 reads the output of the sensor subsystem 180. The output of the sensor subsystem 180 constitutes the current profile. At step 240, the control code determines if current profile is within a preset tolerance of the target profile.

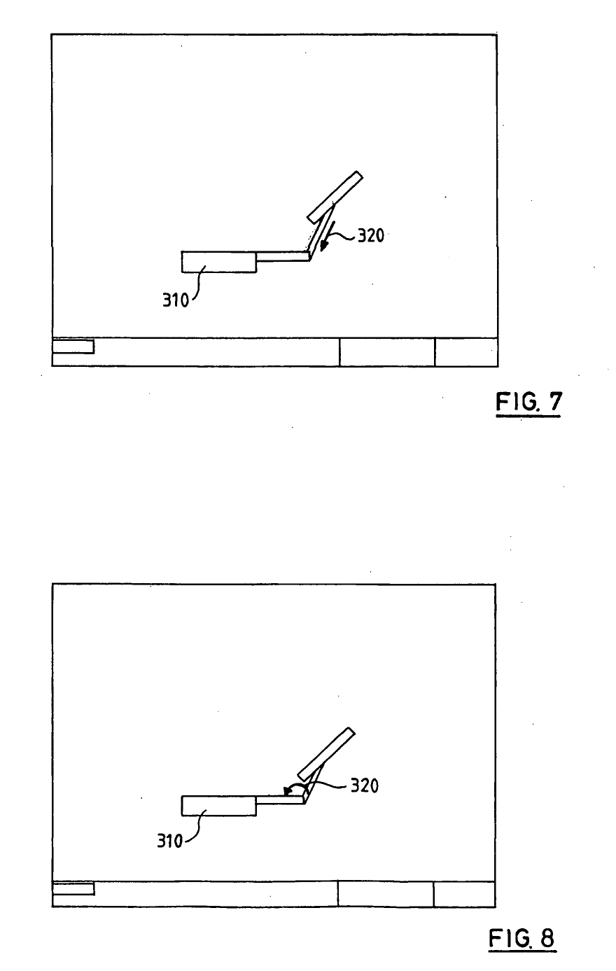

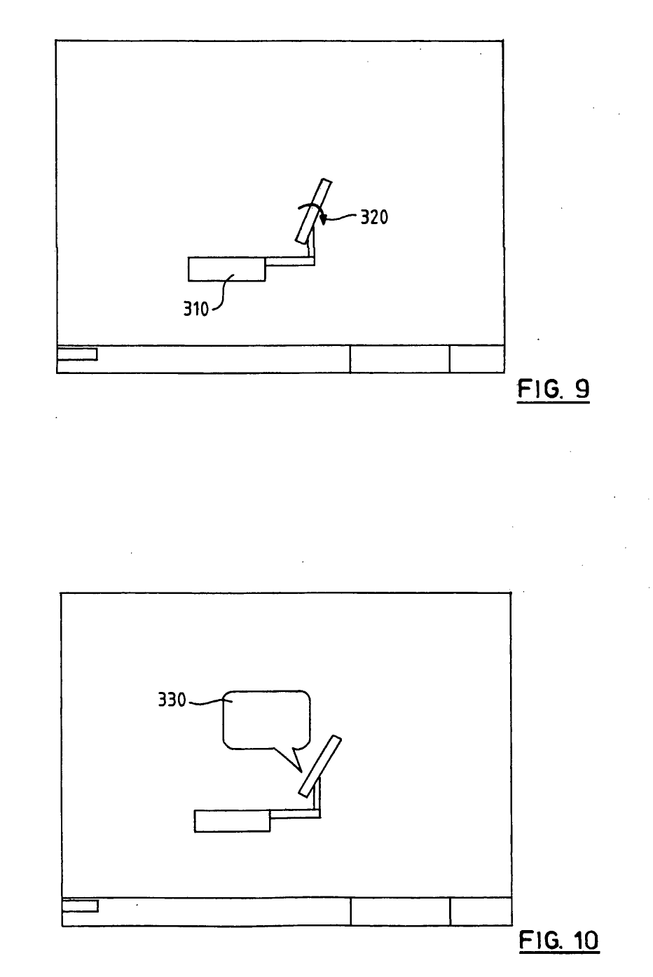

Referring to FIG. 6, if the test at step 240 is negative, then the control code 190 displays an image 310 of the computer system on the display screen 120. The control code 190 also displays an indicator 320 directing showing the user how the display screen 120 should be moved relative to the keyboard 100 to achieve the target profile. In preferred embodiments of the present invention, the indicator 320 is in the form of an arrow. The indicator 320 is generated in dependence on the sensors in the sensor subsystem for which the current readings differ from the target readings by more than the preset tolerance. In FIG. 6, for example, the indicator 320 corresponds to the display screen 120 being too close to the keyboard 100. Accordingly, the arms 171-172 should be extended from the second portion 162 until the corresponding sensors of the sensor subsystem 180 indicate that the current value has reached the target value. Referring to FIG. 7, the indicator 320 here corresponds to the display screen 120 being too high. Accordingly, the display screen 120 should be moved along the arms 171-172 until the corresponding sensors of the sensor subsystem 180 indicate that the current value has reached the target value. Referring to FIG. 8, the indicator 320 here corresponds to the hinge angle of the arms 171-172 being too great. Accordingly, the arms 171-172 should be bent until the corresponding sensors of the sensor subsystem 180 indicate that the current value has reached the target value. Referring to FIG. 9, the indicator 320 here corresponds to the display screen 120 being incorrectly tilted. Accordingly, the display screen 120 should be tilted about the first pivotal axis 173 until the corresponding sensors of the sensor subsystem 180 indicate that the current value has reached the target value.

Returning to FIG. 4, step 230 is then repeated to reread that output of the sensor subsystem 180. Similarly the test at step 240 is repeated. If the result of the test at step 240 is still negative, then step 250 is repeated. It will be appreciated then that the display screen 120 may be brought into the target position via an interactive process, based on display of a series of indicators 320 on the display screen 120.

Once the display screen 120 is positioned such that the current output of the sensor subsystem 180 is at or within a preset tolerance of the target profile, the result of the test at step 240 is positive. The control code 190 determines at step 260 if the target profile was just reached via adjustment of the display screen 120. If not, the control code 190 returns to step 200. If so, the control code 190 signals, at step 260 the user to stop moving the display screen 120. Referring to FIG. 10, the signal may comprise a visual indication 330. Additionally or alternatively, the signal may comprise an audio indication delivered via a loudspeaker in the data processing system. The control code 190 then returns to step 200.

If a difference between the current value and the target value is subsequently detected at step 240, then the control code 190 may generate an overlay on the display screen 120 to offer the user an opportunity to adjust the position of the display screen 120. If the user accepts the offer, by for example clicking on a corresponding icon displayed on the display screen 120, then the process herein before described with reference to steps 240 to 270 may be repeated. If the user declines the offer, then the control code 190 may offer to suspend testing for a preset time period. Such a time period may be preset according to user preference.

Changes in user may detected at step 200 via radio frequency identification (RFID) tags, for example. Specifically, each user may be equipped with an RFID tag carrying a unique ID. The unique IDs are detected by the system and associated with each user by the control code 190. Other techniques for detecting changes in user in also possible.

It will be appreciated that the embodiment of the present invention herein before described provides swift guidance in positioning the display screen 120 relative to the keyboard 100. As herein before described, in a preferred embodiment of the present invention, there is provided a laptop PC in which preferred display screen positions can be saved in profiles. Different profiles may correspond to different users of laptop PC. Similarly different profiles may correspond to different operating environments. Embodiments of the present invention may be modified to detect the form of work being done by the user, to detect the conditions in which the work is being done, and to encourage the user to switch between different positional settings of the display screen 120 to provide variety in an otherwise monotonous working position. It will also be appreciated that the present invention may be equally applicable to other forms of data processing system where users may find it desirable to receive guidance in positioning the display screen 120 relative to the keyboard 100. Such other forms of data processing system may include desktop systems, for example.

It will appreciated that various functions of the control code 190 herein before described may be at least partially implemented in other embodiments of the present invention by hard wired electronic circuitry. Equally, it will be appreciated that various functions of the control code 190 may be implemented by a combination of computer program code and hard wired electronic circuitry.

1. A data processing system comprising: a display screen; a keyboard; a sensor subsystem for generating an output dependent on a position of the display screen relative to the keyboard; a memory for storing one or more outputs from the sensor subsystem; a comparator for generating feedback indicative of a difference between a current output from the sensor subsystem and an output stored in the memory; and communication means for communicating the feedback to a user of the data processing system.

2. A system as claimed in claim 1, further comprising means for selecting one of a plurality of outputs from the sensor subsystem stored in the memory, wherein the feedback generated by the comparator is indicative of a difference between the output from the sensor subsystem and the selected output.

3. A system as claimed in claim 1, wherein the communication means displays an image indicative of the feedback on the display screen.

4. A system as claimed in claim 1, wherein the sensor subsystem comprises at least one rotational sensor for sensing an angle of tilt of the display screen relative to the keyboard, and at least one linear sensor for sensing a distance between the display screen and the keyboard.

5. A system as claimed in claim 1, wherein the output from the sensor subsystem comprises a plurality of values each associated with a different sensor of the sensor subsystem.

6. A system as claimed in claim 1 in the form of a laptop computer system having a bivalve enclosure comprising a first portion and a second portion wherein the display screen is located in the first portion and the keyboard is located in the second portion.

7. A method for positioning a display screen of a data processing system relative to a keyboard of the data processing system, the method comprising: generating, via a sensor subsystem, an output indicative of a position of the display screen relative to the keyboard; storing one or more outputs from the sensor subsystem; generating feedback indicative of a difference between the output from the sensor subsystem and an output stored in the memory; and, communicating the feedback to a user of the data processing system.

8. A method as claimed in claim 7, further comprising selecting one of a plurality of outputs from the sensor subsystem stored in the memory, wherein the feedback generated is indicative of any difference between the output from the sensor subsystem and the selected output stored in the memory.

9. A method as claimed in claim 7, wherein the communicating comprises displaying an image indicative of the feedback on the display screen.

10. A method as claimed in any of claim 7, wherein the output from the sensor subsystem comprises a plurality of values each associated with a different sensor of the sensor subsystem.
